(19) United States
(12) Patent Application Publication
(10) Pub. No.: US 2025/0277094 A1
(43) Pub. Date: Sep. 4, 2025

(54) HIGH PERFORMANCE, LOW-DENSITY PLA-BASED FOAM AND ASSOCIATED FORMULATIONS AND METHODS

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 19/069,675

(22) Filed: Mar. 4, 2025

Related U.S. Application Data
(60) Provisional application No. 63/560,951, filed on Mar. 4, 2024.

(51) Int. Cl. C08J 9/00; C08J 9/228

(52) U.S. Cl. CPC C08J 9/0066; C08J 9/228; C08J 2201/02; C08J 2367/04

(57) ABSTRACT

Molded foam articles comprising polylactic acid and one or more additives are described herein. The additives may include iron oxide, iron hydroxide, titanium dioxide, zinc oxide, or another additive. The additives advantageously enable the formation of a molded foam article with a lower density without loss in mechanical or thermal performance and, in some cases, improved thermal performance due to advantageous circularity properties of the molded foam beads.

### CROSS-REFERENCE TO RELATED APPLICATION

This application claims priority to U.S. Provisional Patent Application No. 63/560,951, filed Mar. 4, 2024, which is incorporated herein by reference.

### FIELD OF THE DISCLOSURE

This disclosure relates generally to foam articles and, in particular, relates to molded bead foam articles formed from polylactic acid and one or more additives.

### BACKGROUND

Foam articles are used in a variety of diverse industries including thermal insulation and protective packaging, construction, infrastructure support, foodservice, and consumer products such as surfboards. Foam articles are commonly produced from expandable polystyrene (EPS), which has a well-known manufacturing process, and may take the form of molded foam articles, sheet foam articles, foam film articles, or injection molded articles. However, EPS-based foam articles suffer from a variety of drawbacks including the generation of waste due to poor recyclability, the presence of volatile organic blowing agents demonstrated to have detrimental climate effects, and limited compression cycles.

Prior attempts to reduce foam article waste have included a shift towards biobased and compostable foam materials as alternatives to EPS. For example, polylactic acid (PLA) can be used to produce foam articles having insulative and protective properties equal to or superior to those of EPS, but with the added benefit of being compostable. However, there remains a need to reduce cost, increase yield, and improve the properties of molded bead foam articles, including those formed from PLA.

Accordingly, improved foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is an optical microscopy image of pre-molded PLA-based beads without additives.

FIG. 2 is an optical microscopy image of pre-molded PLA-based beads with additives, in accordance with the present disclosure.

FIG. 3 is an optical microscopy image of post-molded PLA-based beads without additives.

FIGS. 4A and 4B are optical microscopy images of pre- and post-molded beads, in accordance with the present disclosure.

FIG. 5 is a chart of temperature/time for molded foam articles in accordance with the present disclosure.

### DETAILED DESCRIPTION

Foam articles are provided herein including foam articles formed from expandable polylactic acid (PLA or ePLA) and one or more additives such as iron oxides or iron hydroxides. In particular, it has been unexpectedly discovered that forming foamable beads from polylactic acid and including one or more additives as described herein reduces the density of the resulting foam article while enhancing resistance to thermal energy transfer and mechanical properties. It has been further unexpectedly discovered that the inclusion of one or more additives as described herein reduces the circularity of the expanded foam beads during steam chest molding, improving the adhesion between beads and reducing the quantity and size of gaps between beads through which gas and/or liquid may pass.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Molded Bead Foam Articles

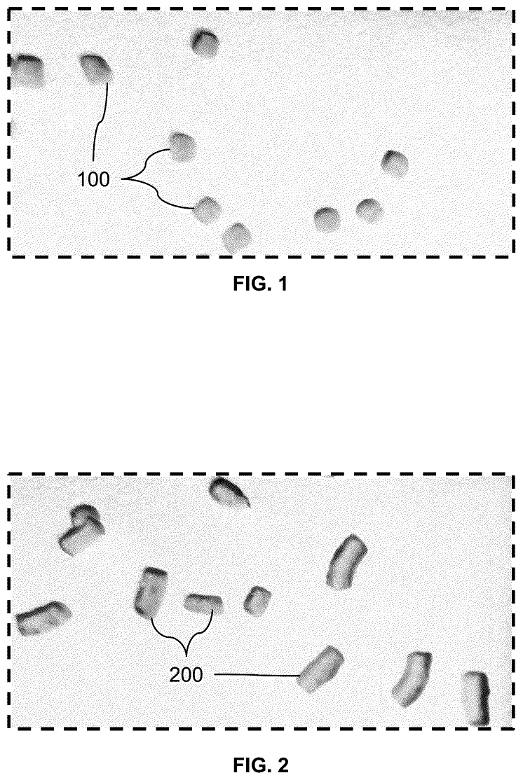

Molded bead foam articles are disclosed herein. In some embodiments, the molded bead foam articles include a plurality of molded beads formed from polylactic acid and may be formed according to the processes described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC, which are each incorporated herein by reference. The plurality of molded beads further include one or more additives selected from: iron oxides, iron hydroxides, titanium dioxides, zinc oxides, aluminum oxides, copper oxides, chromium oxides, manganese oxides, manganese dioxides, barium sulfates, phyllosilicates of iron, iron (III) ferrocyanide, cobalt stannate, potassium hexanitritocobaltate (III), cadmium sulfides, and cadmium sulfoselenides. FIG. 1 depicts a plurality of PLA-based foam beads 100 that do not include any additives, while FIG. 2 depicts a plurality of PLA-based foam beads 200 that include additives as described herein.

In conventional molded bead foam articles, such as those formed from expandable polystyrene (EPS) or from polylactic acid (PLA) without additives, a reduction in the density of the foam correlates to a significant reduction in associated thermal and mechanical properties such as R-value, flexural strength, compression strength, compression set, bend, deflection distance, and shrinkage. In fact, current PLA-based molded foam articles without additives have a lower R-value and less favorable mechanical properties than an EPS-based molded foam article having the same density. Reducing the density of the PLA-based molded foam articles, therefore, would theoretically result in a much poorer foam article with very poor thermal and mechanical properties.

It has been unexpectedly discovered that forming foamable beads from PLA and including one or more additives as described herein reverses the proportionality of density versus thermal and mechanical properties. In other words, by incorporating one or more additives, such as iron oxide, the density of the resulting molded bead foam article may be reduced while maintaining or increasing the thermal and mechanical properties. The result is a PLA-based molded foam article with the same or better thermal and mechanical properties as a conventional PLA-based molded foam article, but with a much lower density. This translates to a lower weight article and associated improvements in shipping costs and efficiency.

It has been further unexpectedly discovered that the PLA-based molded foam articles with additives as described herein produces a foam article with beads having low circularity. These beads are capable of expanding into irregular shapes that more effectively fit in between adjacent beads, thereby producing a more robust molded foam article with fewer gaps between beads. The resulting molded foam articles are resistant to moisture and gas transfer so that, for example, a container may be formed capable of holding liquid or dry ice, and otherwise prevent leaks.

In some embodiments, the molded bead foam article includes iron oxide or iron hydroxide derived from one or more different sources. For example, the iron oxide or iron hydroxide may be derived from mica or clay. The iron oxide or iron hydroxide may include hematite, limonite, yellow hydrated oxide, iron hydroxide pigment, venetian red, sienna, raw sienna, burnt sienna, goethite, mars pigments, mars yellow, yellow earth, jarosite, yellow iron oxide, red iron oxide, ferrihydrite, or caput mortuum, each of which vary only slightly in their mineral compositions. The iron containing additive may include prussian blue, turnbull's blue, cerulean blue, iron blue, yellow ochre, umber, green earth, mica iron oxides, red ochre, red earth, brown ochre, burnt umber, or mummy brown, each of which vary largely in their coloration due to small changes in mineral composition or source. However, the exclusion of a specific mineral name is in the interest of brevity only. The iron containing additive may come from a natural source or may be synthetic.

In some embodiments, the molded bead foam article includes titanium dioxide, zinc oxide or zinc white, aluminum oxide, copper oxide, chromium oxide, baryte, celadonite, glauconite, cobalt yellow, cadmium yellow red, cadmium orange, or pyrolusite.

In some embodiments, the one or more additives are present in an amount of from about 0.2% to about 5% by weight.

In some embodiments, the plurality of molded beads may include talc, graphite, or both. For example, in some embodiments, the plurality of molded beads may include natural graphite, synthetic graphite, and/or expandable graphite.

In some embodiments, the molded bead foam article may be in the form of a shipper that is used without the addition of any other material. For example, the molded bead foam article may consist of the PLA-based formulations described herein, without the use of corrugated cardboard, tape, glue, or any other material that would otherwise be used for mechanical or thermal reinforcement. In other words, in some embodiments, the molded bead foam article has the mechanical and thermal performance described herein without the use of corrugated cardboard.

### Methods of Forming Molded Bead Foam Articles

Methods of forming molded bead foam articles are also disclosed herein. In some embodiments, the molded bead foam articles are formed according to the processes described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC, which are each incorporated herein by reference.

In some embodiments, the methods include compounding a resin comprising polylactic acid and one or more additives selected from: iron oxides, iron hydroxides, titanium dioxides, zinc oxides, aluminum oxides, copper oxides, chromium oxides, manganese oxides, manganese dioxides, barium sulfates, phyllosilicates of iron, iron (III) ferrocyanide, cobalt stannate, potassium hexanitritocobaltate (III), cadmium sulfides, and cadmium sulfoselenides. In some embodiments, the methods include pelletizing the resin to form a plurality of foam beads, followed by molding the plurality of foam beads to form the molded bead foam article.

In some embodiments, the molding process is performed on conventional EPS molding machines. It has been unexpectedly discovered that the inclusion of additives in the PLA-based resin, as described herein, enables the use of conventional EPS-based molding machines and techniques. In contrast, PLA-based resins without the additives described herein have a lower glass transition temperature that increases the resins' sensitivity to heat; the conventional EPS-based techniques must therefore be modified to effectively mold PLA-based resins without additives.

In some embodiments, molding the plurality of foam beads is performed at about 1 bar of pressure for about 60 seconds.

### EXAMPLES

PLA-based molded foam articles were formed as described herein and included one or more of talc, iron oxide, and graphite. The iron oxide used was micronized uncoated synthetic iron oxide, Chemical Abstracts Service (CAS) Registry Number 1309-37-1, available commercially from Paramount Colors, Inc, Elgin, Illinois, USA. The talc used was JETWHITE® talc, a micronized mined talc with a particle size of under 7 microns available commercially from Magris Performance Materials, Inc., Toronto, Ontario, Canada. The graphite used was Asbury 3538 intercalated flake graphite, a micronized mined graphite available commercially from Asbury Carbons, Asbury, New Jersey, USA. The formulations tested are summarized in Table 1.

TABLE 1
Formulations Tested

| Sample | Talc, wt % | Iron Oxide, wt % | Graphite, wt % |
|---|---|---|---|
| PLA-N | 0.5 | 0.2 | 0.3 |
| PLA-J | 0.6 | 0.8 | |
| PLA-H | 0.3 | | 0.45 |
| PLA-E | 0.2 | | 0.3 |
| PLA-A | 0.3 | | |
| PLA-D | 0.5 | | 0.6 |
| PLA-C | 0.5 | | 0.7 |
| PLA-M | 0.4 | 0.4 | 1.0 |
| PLA-B | 0.5 | | 0.6 |
| PLA-L | 0.24 | 0.25 | 0.6 |
| PLA-F | 0.2 | | 0.3 |
| PLA-G | 0.5 | 0.4 | 0.3 |
| PLA-I | 0.75 | | |
| PLA-K | 0.3 | 0.4 | |

### Example 1: Leak Resistance Test

PLA-based molded foam articles were produced as described herein and according to formulations PLA-A, PLA-J, and PLA-H. A plastic wide-mouth container having a 2 inch diameter opening was pressed into the planks to a depth of 0.25 inches so that an impression of the opening was created by the container opening. The container was filled with 400 mL of water and the plank was fitted to the top of the container by mating the impression in the plank with the opening of the container. The plank and container were then inverted so that the water in the container rested on the plank so that the plank may be tested for any water leakage. After 1 minute, the underside of the plank was checked to determine if water had leaked through the plank. A similar observation was made after 3 minutes, 5 minutes, 10 minutes, 20 minutes, 60 minutes, 2 hours, 4 hours, 6 hours, 8 hours, and 24 hours.

Sample PLA-A, which represents a more conventional PLA-based formulation that includes only talc, began to leak almost immediately. Clear beading was observed on the underside of the plank after 1 minute, and a small puddle began to form after 3 minutes. The test was stopped after 5 minutes due to the amount of water escaping through the plank.

Sample PLA-H, which resembles a PLA-based molded article such as the one described in U.S. patent application Ser. No. 18/303,209 to Lifoam Industries, LLC, was examined after 1 minute, 3 minutes, 5 minutes, 10 minutes, 20 minutes, 60 minutes, 2 hours, and 4 hours with no sign of beading or water transfer through the plank. After 6 hours, minor water beading was observed. After 8 hours, a few small puddles were observed.

Sample PLA-J, which includes additives as described herein, was examined after each of the aforementioned time periods with no signs of seeping water. Another observation was made after 72 elapsed hours with no change in water level or seepage of water through the plank. This demonstrates that the inclusion of iron oxide in an amount of only 0.8% by weight can dramatically improve the ability for the PLA-based molded article to hold water or other liquids for long periods of time.

### Example 2: R-Value Measurements

PLA-based foam articles were produced having the same size and shape as the planks in Example 1 and according to formulations PLA-D, PLA-C, PLA-M, PLA-B, PLA-L, PLA-F, PLA-G, PLA-I, PLA-K, PLA-J, AND PLA-A. Each sample's thermal conductivity was measured using a FOX304 thermal heat flow meter, available commercially from TA Instruments/Lasercomp, Inc. Each sample's thickness was automatically measured by the heat flow meter during measurement and used by the FOX304 and the WinTherm software, available commercially from Lauda Dr. R. Wobser Gmbh & Co. Kg, Lauda-Königshofen, Germany, to calculate R-value and thermal conductivity. The samples were measured at an average temperature of 23° C. and a temperature gradient of 25° C., with the lower plate being 10.50° C. and the upper plate being 35.50° C. The results of the test are presented in Table 2.

TABLE 2
R-Values for PLA-Based Molded Articles

| Specimen ID | R value/inch | Density (pcf) | R-Value/Density (pcf) |
|---|---|---|---|
| PLA-D | 4.18 | 1.50 | 2.79 |
| PLA-C | 4.14 | 1.60 | 2.59 |
| PLA-M | 4.03 | 1.35 | 2.99 |
| PLA-B | 4.01 | 1.43 | 2.80 |
| PLA-L | 4.00 | 1.29 | 3.12 |
| PLA-F | 4.00 | 1.43 | 2.79 |
| PLA-G | 3.90 | 1.30 | 3.00 |
| PLA-N | 3.92 | 1.24 | 3.17 |
| PLA-I | 3.91 | 1.38 | 2.83 |
| PLA-K | 3.85 | 1.45 | 2.66 |
| PLA-J | 3.80 | 1.26 | 3.02 |
| PLA-A | 3.76 | 1.71 | 2.20 |

As shown in Table 2, the highest R-value/inch sample was realized when graphite was used with talc. The next highest are when both iron oxide and graphite were used. Some of the graphite-only samples such as PLA-F demonstrated favorable results, but comparing the various samples that include graphite, but not iron oxide, demonstrated a range of performances. Increasing the amount of talc appeared to increase R-Value but the magnitude of this increase was substantially lower than the effect of increasing graphite or iron oxide. Lastly, it appeared that only having iron oxide in an amount such as 0.4% and 0.8% by weight, without graphite, had lower R-values compared to the samples that include graphite, but the inclusion of only iron oxide resulted in an R-value that was greater than Sample PLA-A (which omits both iron oxide and graphite).

One of the most critical factors in R-value and thermal conductivity is the density of the material being used. In many situations, it is more economical and environmentally friendly to reduce the weight of packaging, even if such weight reduction comes with a reduction in the R-value, because the thickness of the article may be increased. This thickness increase can result in equivalent thermal performance, even with a reduced R-value, without increasing the overall weight of the article due to the lower density. Table 2 demonstrates that, even though Sample PLA-D has the highest R-Value, Sample PLA-N has the lowest density and Sample PLA-L had properties somewhere in between. In other words, a container formed from Sample PLA-L may be preferred compared to a container formed from Sample PLA-D, even with a lower R-value, because of the significantly lower density.

Therefore, in some embodiments, the molded bead foam articles described herein may have a density of between about 1.2 to about 1.4 pcf. In some embodiments, the molded bead foam articles have a density of less than about 1.3 pcf. In some embodiments, the molded bead foam articles have an R-Value/Density of at least 3 pcf⁻¹, which may be achieved by either lowering the density or increasing the R-Value.

### Example 3: Reduction in Density

As displayed in Table 2, the density of the PLA-based molded foam article decreased significantly with addition of iron oxide. Previously attempts to reduce the density included increasing the amount of talc or graphite, enabling a density reduction from about 1.6-1.7 pcf observed with standard level of talc down to about 1.4-1.6 pcf. With the addition of iron oxide, with or without graphite, molded and conditioned densities as low as 1.24 pcf were realized, with multiple samples testing below 1.3 pcf.

### Example 4: Mechanical Property Improvement

Table 3, below, displays flexural strength data collected in accordance to ASTM C203, Standard Test Methods for Breaking Load and Flexural Properties of Block-Type Thermal Insulation. For each material, four molded articles were prepared having a length of 12 inches and a width of 3 inches. The thickness of each material varied depending on the level of shrinkage or expansion but was generally targeted at about 2.125 inches. However, the data are adjusted for minor differences in thickness. The flexural strength and the elastic modulus when bending were calculated according ASTM C203. The deflection distance was measured as the maximum deflection distance before failure or breakage of the sample. The data in Table 3 are averaged from four individual tests conducted on each sample type.

TABLE 3
Mechanical Properties of Molded Planks

| | | Deflection | Elastic | Flexural | Flexural |
|---|---|---|---|---|---|
| | Density | Distance | Modulus | strength | Strength/Density |
| ID | (pcf) | (in) | (psi) | (psi) | (psi/pcf) |
| PLA-J | 1.26 | 1.05 | 168 | 38 | 30 |
| PLA-L | 1.29 | 0.76 | 237 | 37 | 29 |
| PLA-G | 1.24 | 0.76 | 237 | 36 | 29 |
| PLA-K | 1.45 | 0.70 | 248 | 36 | 24 |
| PLA-D | 1.50 | 0.59 | 326 | 36 | 24 |
| PLA-I | 1.38 | 0.56 | 271 | 30 | 22 |
| PLA-F | 1.43 | 0.74 | 203 | 30 | 21 |
| PLA-A | 1.71 | 0.43 | 472 | 36 | 21 |
| PLA-M | 1.35 | 0.66 | 214 | 28 | 21 |
| PLA-B | 1.43 | 0.70 | 215 | 28 | 20 |
| PLA-C | 1.60 | 0.50 | 323 | 30 | 19 |

As shown in Table 3, the flexural strength divided by the density illustrates the benefits of adding iron oxide to the PLA-based molded article. In other words, the addition of iron oxide greatly improves the amount of flexural strength achieved per pound of material. Without iron oxide, previous PLA-based formulations achieved 20-24 psi per pound of material, but with the addition of iron oxide, the scaled flexural strength reached 29-30 psi per pound of material.

### Example 5: Quantifying the Amount of Shrinkage

Molded foam articles were formed according to compositions PLA-A, PLA-G, and PLA-J. The dimensions of the molded foam articles before and after molding (i.e., the dimensions of the mold versus the dimensions of the molded article) were measured to quantify the degree of shrinkage experienced by the molded foam article, with 0% shrinkage being the more desired result. Sample PLA-A experienced a 2.3% reduction in size as compared to the mold dimensions. Sample PLA-G experienced as 0.5% reduction in size as compared to the mold dimensions. Sample PLA-J experienced no shrinking; in fact, this sample expanded by from about 0% to about 2%. This experiment demonstrated that the inclusion of iron oxide, with or without graphite, results in a reduction in the amount of shrinkage experienced by the molded article.

PLA has a lower glass transition temperature and is therefore more sensitive to the heat, pressure, and duration of molding cycles compared to EPS. As a result, an EPS molding process and/or molding equipment may need to be modified for molding PLA without additives. It was unexpectedly discovered that the inclusion of both graphite and iron oxide enabled the use of conventional EPS-based molding techniques to form the PLA-based molded foam article. Pressures of up to around 1 bar and cycle times of around 65 seconds were feasible for the PLA-based molded foam articles with additives, whereas the pressure is limited to around 0.4 bar and the cycle time is limited to around 45 seconds for PLA-based molded foam articles without additives.

### Example 6: Image Analysis of Foam Beads

Molded foam articles were formed according to PLA-A, PLA-J, PLA-H, and PLA-N and took the form of 2-inch thick planks. B-sized and C-sized EPS-based molded articles were also formed for comparison. The molded planks were wire cut so that a flat exposed internal surface was created to study expanded beads. Thirty individual beads were selected on the exposed surface and colored with a black marker. The beads were selected across the thickness of the plank so that beads at the edges and at the center were colored, and no colored bead was adjacent to another colored bead. A 3-inch tall “shadow-box” with a cutout was used to limit lightning so that a photo could be captured and uploaded into “ImageJ .JS powered by Imjoy,” an open-source, public domain image processing software. The software was used to analyze various parameters of the expanded beads and molded beads from panel samples. The images were converted to an 8-bit colorspace, removing all color from the image. A threshold was then adjusted using a color threshold with the default thresholding method and dark background. The result of image manipulation highlighted the individual colored beads from the background and from other, uncolored beads. The colored beads were then selected using the wand tracing tool and all outside noise was cleared so that only the individual beads remained for analysis. The dimensions for each bead were then measured.

The parameters analyzed using the ImageJ .JS software were area, perimeter, Feret diameter, minimum Feret diameter, and circularity. Area is the sum of square pixels (converted to inches) for each individual bead. The perimeter was the computed length of the outside boundary of each bead selection. The Feret diameter is the longest distance between any two points along the selection boundary, also known as the maximum caliper. The minimum Feret diameter is the minimum caliper diameter between any two points along the selection boundary. Circularity is calculated by the equation:

$$Circularity = \frac{4 μ \times area}{{perimeter}^{2}} \times 100 \%$$

where a value of 100% indicates a perfect circle while a value closer to 0% is increasingly elongated.

The results of the measurements were averaged over the 30 beads and are displayed in Table 4 for beads pre-molding and in Table 5 for beads post-molding. The pre-molding beads refer to beads that have been pelletized and allowed to rest for 24 hours, which results in a small increase in density as the pelletized polymer foam degasses. The post-molding beads refer to beads that have been pelletized, allowed to rest for 24 hours, and then molded via steam chest molding. No pre-expansion step is necessary because the pelletized beads are already in foam form. After pelletization, the beads have a cylindrical shape.

TABLE 4
Dimensions of Molded Beads (Before Molding)

| | Area | Perimeter | Feret Diameter | Minimum Feret | |
|---|---|---|---|---|---|
| ID | (in²) | (in) | (in) | Diameter (in) | Circularity |
| PLA-A | 0.002 | 0.186 | 0.062 | 0.043 | 68% |
| PLA-J | 0.005 | 0.334 | 0.106 | 0.061 | 58% |
| PLA-H | 0.001 | 0.17 | 0.053 | 0.041 | 62% |

TABLE 5
Dimensions of Molded Beads (After Molding)

| | Area | Perimeter | Feret Diameter | Minimum Feret | |
|---|---|---|---|---|---|
| ID | (in²) | (in) | (in) | Diameter (in) | Circularity |
| PLA-A | 0.015 | 0.524 | 0.162 | 0.127 | 66% |
| PLA-J | 0.023 | 0.785 | 0.213 | 0.145 | 47% |
| PLA-H | 0.014 | 0.477 | 0.159 | 0.115 | 74% |
| PLA-N | 0.027 | 0.83 | 0.233 | 0.16 | 49% |
| EPS | 0.009 | 0.418 | 0.126 | 0.106 | 66% |

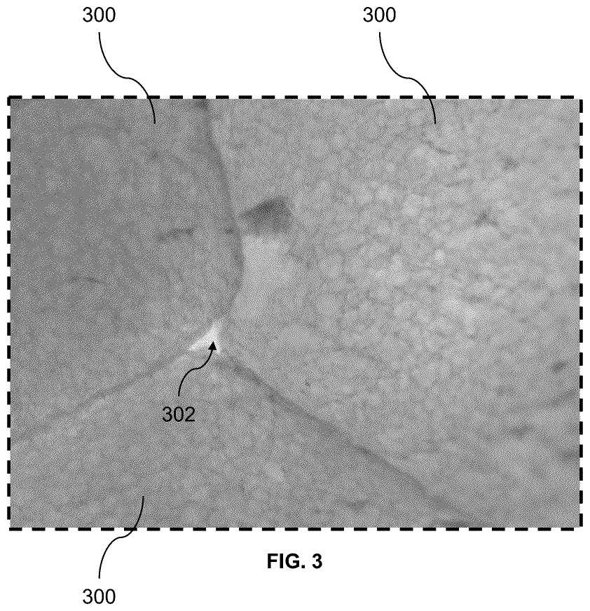

FIG. 3 depicts optical microscopy of the post-molded beads for formulation PLA-A (i.e., the PLA-based formulation with no additives). Three beads 300 are visible in FIG. 3 and a void 302 is visible where the beads 300 intersect, illustrating the beads' tendency to retain their original cylindrical or circular shape as they expand. This results in a void 302 where the beads are unable to expand, which contributes to poorer thermal performance and gas/liquid retention.

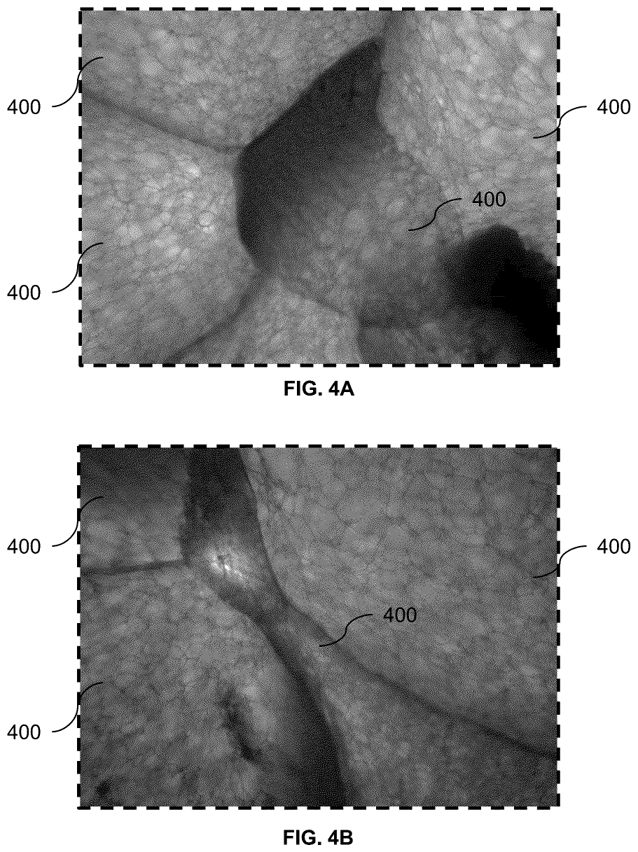

FIGS. 4A and 4B depict optical microscopy of the post-molded beads for formulation PLA-J, with several beads 400 visible. The low circularity of the beads enables the beads to distort into irregular shapes that differ greatly from their initial circular or cylindrical shape, allowing them to more completely fill in the gaps between neighboring beads. This improves adhesion and reduces gaps between beads, thereby improving water and gas retention.

Several interesting trends were observed. First, while each of the bead types started with a different area and perimeter prior to molding, they all expanded significantly during the molding process. Second, the beads with iron oxide additive were larger prior to molding, and yet experienced further expansion and retaining the largest cross-sectional area during the molding process. Third, the average Feret diameter in PLA-A and PLA-H molded materials was 0.162 inches and 0.159 inches, respectively, while PLA-J was 0.213 inches while the minimum Feret diameter for PLA-A and PLA-H was 0.127 inches and 0.115 inches, respectively, while PLA-J had a minimum Feret diameter of 0.145 inches. This demonstrates that the samples had approximately the same degree of irregularity in their size.

Finally, as the beads are mostly circular or cylindrical prior to molding, the circularity of the beads after molding may be used to determine if the beads expanded in a manner effective to fill open spaces and close up voids between them. In other words, a high circularity indicates the beads retained much of their pre-molding circular shape, while a lower circularity indicates that the beads shift their shape from their initial circular shape to an irregular shape to adapt to the surrounding geometry. While PLA-A and PLA-H had circularities on average of 66% and 74%, indicating beads are closer to circular in form, PLA-J had circularity of 47%. The same image analysis was performed on a molded article formed from formulation PLA-N which demonstrated an even greater degree of expansion with foam beads having areas of 0.027 inches and perimeters of 0.830 inches. These beads had a Feret diameter of 0.233 inches and minimum Feret diameter of 0.160 inches. These beads also had a circularity of 49%. This demonstrates that the inclusion of iron oxide not only results in larger beads, but results in beads with greater deviation from circularity capable of expanding into the surrounding void. This improves adhesion, reduces pathways for thermal energy transfer, and reduces or eliminates gaps through which liquid may flow.

Therefore, in some embodiments, the molded bead foam articles described herein may be formed from a plurality of molded beads that have an average circularity of less than about 50%.

### Example 8: Testing Mechanical Properties after Contact with Moisture

In conventional biobased thermal insulation materials, such as paper- or starch-based containers, the mechanical properties change after contact with water because both paper and starch begins to degrade or dissolve. The PLA-based panels described herein were immersed in water and were kept submerged using a weight. The panels were kept submerged overnight and then tested according to ASTM C203, as described in Example 4. The results are displayed in Table 6. Around a 2% change in flexural strength was observed.

TABLE 6
Mechanical Properties of Molded Planks after Being Submerged

| | | Deflection | Elastic | Flexural | Change in |
|---|---|---|---|---|---|
| | Density | Distance | Modulus | strength | Flexural |
| ID | (pcf) | (in) | (psi) | (psi) | Strength |
| PLA-J | 1.27 | 0.95 | 177 | 37.3 | −1.8% |
| PLA-L | 1.29 | 0.82 | 222 | 36.2 | −2.2% |
| PLA-G | 1.25 | 0.72 | 219 | 36.4 | +1.1% |

### Example 9: Formulating a Molded Foam Article

Molded foam articles were formed as described herein, taking the form of foam planks having a 1.5 inch thickness. The expandable beads incorporated 4% by weight of micronized synthetic iron oxide (Fe₂O₃, CAS 1309-37-1) as an additive component. For this trial, no talc or graphite was added.

The molded structures exhibited minimal post-expansion deviation of 1% from nominal dimensions. The molded foam article achieved a density of 1.5 pounds per cubic foot while maintaining thermal resistance properties with an R-value of 3.8 per inch. Notably, increased concentrations of the iron oxide additive demonstrated no detrimental effects on either the bead density or the mechanical and thermal performance characteristics of the finished components. The uniform dispersion of the iron oxide throughout the polymer matrix contributed to consistent material properties across the molded foam article.

### Example 10: Comparison of Different Iron Oxide Additives

Comparative analyses were conducted utilizing two distinct iron oxide variants for bead formation and the foam article molding processes. The first variant comprised micronized yellow iron oxide (FeO(OH), CAS 51274-00-1), while the second utilized an alternative Fe₂O₃ formulation exhibiting bluish-red chromatic characteristics (CAS 1309-37-1). Additional trials investigated the synergistic effects of combining both micronized yellow and micronized red variants in the same formulation. Finally, a trial was conducted which included micronized yellow and micronized red variants as well as graphite particles in a single formulation. All experimental formulations included 0.75% by weight talc.

The thermal resistance properties, density measurements, and efficiency ratios (expressed as R-value per unit density) were quantified for each formulation, as displayed in Table 7.

TABLE 7
Comparison of Iron Oxide Additives

| Specimen | R-value | Density (pcf) | R-Value/Density (pcf) |
|---|---|---|---|
| Micronized Yellow | 3.91 | 1.28 | 3.05 |
| Micronized Red | 4.00 | 1.45 | 2.75 |
| Micronized Yellow + | 3.85 | 1.42 | 2.71 |
| Micronized Red | | | |
| Micronized Yellow + | 4.01 | 1.49 | 2.69 |
| Micronized Red + | | | |
| Graphite | | | |

The micronized yellow iron oxide formulation demonstrated superior efficiency with an R-value/density ratio of 3.05, achieving an R-value of 3.91 at a density of 1.28 pcf. The micronized red iron oxide formulation exhibited enhanced thermal resistance as demonstrated by an R-value of 4.00 but at a correspondingly higher density of 1.45 pcf, resulting in an efficiency ratio of 2.75. As described previously, it may be advantageous to utilize a lower R-value at a lower density because the reduced thermal performance may be mitigated by an increased thickness, resulting in comparable thermal performance at a lower weight. This is reflected in the R-Value/Density calculation.

Two independent trials investigating the combined micronized yellow and red formulations yielded consistent results, with R-values ranging from 3.85 to 4.01 and densities from 1.42 to 1.49 pcf, corresponding to efficiency ratios of 2.71 and 2.69 respectively. These results demonstrate the reproducibility of the combined formulation properties while maintaining thermal performance within acceptable parameters.

### Example 11: Moisture Barrier Performance

Water barrier testing was performed on molded foam articles in the form of boxes fabricated from the combined micronized yellow and red iron oxide formulation described in Example 10, with each having a density of 1.42 pounds per cubic foot. The test specimens featured internal dimensions of 8×6×8 inches with 1.5-inch thick walls. A water volume of 1000 milliliters was introduced into each test box to evaluate leak resistance against fluids. After a 72-hour test period, no water leakage was observed beneath the specimens, and the full 1000-milliliter volume was successfully recovered, demonstrating effective moisture barrier performance.

### Example 12: Gas Retention Test

Performance analysis of PLA-based molded foam containers with and without iron oxide additives revealed significant differences in both gas retention and thermal characteristics. Standard PLA-based formulations without iron oxide demonstrated poorer water barrier properties, which correlates with increased gas permeability through container walls. This increased permeability appears to facilitate supercooling when tested with dry ice (solid CO₂) as a cooling medium.

The supercooling phenomenon observed in standard PLA-based containers results in two distinct effects: an initial temperature deviation below the expected phase change point and accelerated thermal energy release from the phase change material (PCM). This accelerated energy release compromises the long-term thermal performance of the system.

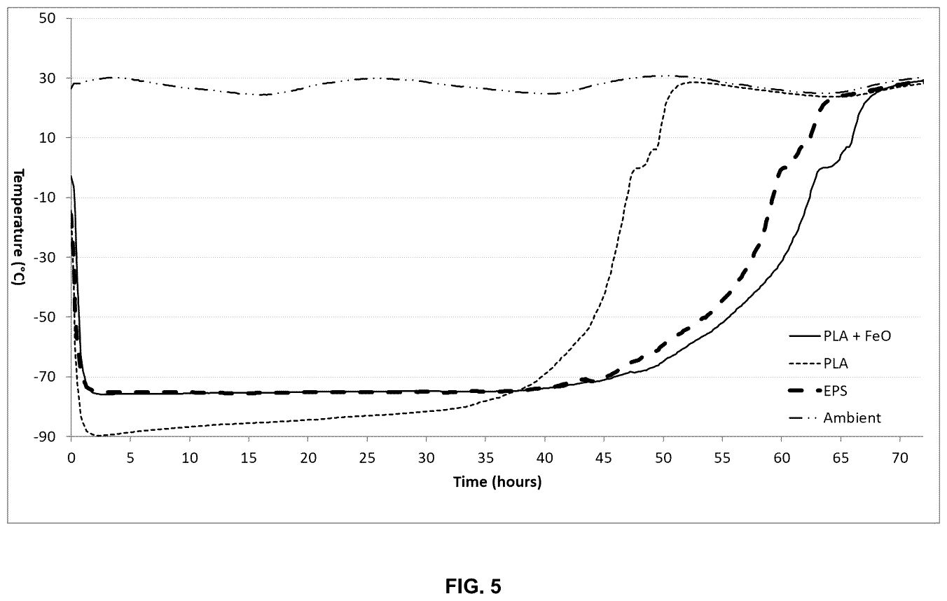

Comparative testing was conducted using three container variants: PLA with iron oxide additive, PLA without iron oxide, and conventional EPS. All test specimens maintained identical internal dimensions of 8×6×8 inches. Each container was loaded with 8 pounds of dry ice and the internal temperature was monitored via centrally positioned temperature probes over a 72-hour duration. The results are depicted in FIG. 5.

Temperature profile analysis demonstrated that PLA containers without iron oxide exhibited supercooling behavior during the initial testing period and reached ambient temperature more rapidly than EPS control specimens. In contrast, PLA containers incorporating iron oxide displayed thermal performance comparable to, or marginally superior to, standard EPS containers throughout the test duration. Furthermore, the PLA container with iron oxide had a density comparable to the EPS container (1.3 pcf for PLA with iron oxide and 1.27 pcf for EPS), while the PLA-based container without additives had a density of 1.55 pcf.

### Example 13: Countertop Composting Trial

Specimens of PLA-J material in both bead form and 1″ cubic configurations were subjected to controlled biodegradation testing in a modified beyondGREEN All-Electric Organic Waste and Pet Waste Composter, available commercially from beyondGREEN Biotech, Inc., Santa Ana, California, USA. The composting chamber was retrofitted with aluminum foil barriers to prevent specimen migration during automated agitation cycles, thereby ensuring continuous thermal exposure throughout the experimental duration.

The chamber was loaded with the PLA-J test specimens, apples that were sectioned into 0.5″ cubic fragments, and a measured quantity of Epoma Organic Compost starter as a microbial inoculant. The automated agitation system was activated to maintain homogeneous conditions. A dual-temperature protocol was implemented wherein the thermal element was calibrated to approximately 165° F. (73.9° C.) during weekday periods, resulting in a measured temperature gradient of 178° F. (81.1° C.) at the chamber's lower boundary and 157° F. (69.4° C.) in the air above the substrate mixture. During weekend periods, the thermal element was recalibrated to approximately 150° F. (65.6° C.), yielding a measured temperature gradient of 155° F. (68.3° C.) at the chamber's lower boundary and 149° F. (65.0° C.) in air above the mix.

The biodegradation process was maintained until complete structural disintegration of the PLA-J specimens was observed. Following a 14-day incubation period, the PLA-J material was no longer visually or physically distinguishable within the substrate matrix, having undergone complete conversion to a homogeneous humic substance with soil-like characteristics. This demonstrates that the addition of iron oxide to the PLA-based molded foam article does not reduce or eliminate the compostability of the resulting foam article.

Though the disclosed examples include particular arrangements of a number of parts, components, features, and aspects, the disclosure is not limited to only those examples or arrangements shown. Any one or more of the parts, components, features, and aspects of the disclosure may be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single element, but the corresponding description should be read to include embodiments of two or more elements. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A molded bead foam article comprising a plurality of molded beads formed from polylactic acid and one or more additives selected from: iron oxides, iron hydroxides, titanium dioxides, zinc oxides, aluminum oxides, copper oxides, chromium oxides, manganese oxides, manganese dioxides, barium sulfates, phyllosilicates of iron, iron (III) ferrocyanide, cobalt stannate, potassium hexanitritocobaltate (III), cadmium sulfides, and cadmium sulfoselenides.

2. The molded bead foam article of claim 1, wherein the plurality of molded beads comprises iron oxide derived from mica or clay.

3. The molded bead foam article of claim 1, wherein the one or more additives are present in an amount of from about 0.2% to about 5% by weight.

4. The molded bead foam article of claim 1, wherein the plurality of molded beads further comprises talc.

5. The molded bead foam article of claim 1, wherein the plurality of molded beads further comprises natural or synthetic graphite.

6. The molded bead foam article of claim 1, wherein the plurality of molded beads further comprises expandable graphite.

7. The molded bead foam article of claim 1, wherein the plurality of molded beads have an average circularity of less than 50%.

8. The molded bead foam article of claim 1, wherein the molded bead foam article has a density of less than about 1.30 pcf.

9. The molded bead foam article of claim 1, wherein the molded bead foam article has an R-Value/Density of at least 3 pcf⁻¹.

10. The molded bead foam article of claim 1, wherein the molded bead foam article is resistant to gas and liquid leaks.

11. A shipper comprising the molded bead foam article of claim 1, wherein no corrugated cardboard is used to form the shipper.

12. A method of forming a molded foam article, the method comprising:
compounding a resin comprising polylactic acid and one or more additives selected from: iron oxides, iron hydroxides, titanium dioxides, zinc oxides, aluminum oxides, copper oxides, chromium oxides, manganese oxides, manganese dioxides, barium sulfates, phyllosilicates of iron, iron (III) ferrocyanide, cobalt stannate, potassium hexanitritocobaltate (III), cadmium sulfides, and cadmium sulfoselenides;
pelletizing the resin to form a plurality of foam beads; and
molding the plurality of foam beads to form the molded bead foam article.

13. The method of claim 12, wherein molding the plurality of foam beads is performed on an expandable polystyrene (EPS) molding machine.

14. The method of claim 12, wherein molding the plurality of foam beads is performed at about 1 bar of pressure for about 60 seconds.
